(19) United States
(12) Patent Application Publication
(10) Pub. No.: US 2005/0285927 A1
(43) Pub. Date: Dec. 29, 2005

(54) Image forming device and an exposure member for the device

(75) Inventor: Alphonse D. Camp, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/874,888

(22) Filed: Jun. 23, 2004

(51) Int. Cl. B41J 2/435

(52) U.S. Cl. 347/224

(57) ABSTRACT

The present invention relates to an image-forming device for processing photosensitive media. The photosensitive media is of the type that includes microcapsules that encapsulate imaging material such as coloring material. The image-forming device includes an exposure member that includes a digital projector that is adapted to simultaneously expose the full image area of media to be developed.

### CROSS REFERENCE TO RELATED APPLICATIONS

Reference is made to commonly-assigned U.S. patent application Ser. No. 10/687,939 filed Oct. 17, 2003, entitled IMAGING ELEMENT HAVING PROTECTIVE OVERCOAT LAYERS to Hwei-Ling Yau et. al.; U.S. application Ser. No. 10/722,248 filed Nov. 25, 2003, entitled AN IMAGE FORMING DEVICE HAVING A BRUSH TYPE PROCESSOR to Alphonse D. Camp et. al.; and U.S. patent application Ser. No. 10/621,785 filed Jul. 17, 2003 entitled IMAGE FORMING DEVICE HAVING A PHOTOBLEACH SYSTEM to Alphonse D. Camp, et al.

### FIELD OF THE INVENTION

The present invention relates to an image forming device for processing photosensitive media, wherein the photosensitive media includes a plurality of microcapsules that encapsulate imaging material such as coloring material. The present invention further relates to an exposure member of the image forming device.

### BACKGROUND OF THE INVENTION

Image forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The media further comprises a monomer and the appropriate cyan, magenta or yellow photo initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leuco dye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is uniformly applied across the image. As a final fixing step, heat is applied to accelerate color development and to extract all un-reacted liquid from the microcapsules. This heating step also serves to assist in the development of available leuco dye for improved image stability. Generally, pressure ruptured capsules (unhardened) expel lueco dye into the developer matrix.

Approximately 100 mega Pascal or 14,500 psi normal pressure was required for capsule crushing as documented in prior art. This need for precise application of high pressure (high compressive forces) presented a limitation to the extensibility of the conventional imaging system. Small compact low cost printers typically employed micro-wheels or balls backed by springs and operate in a scanning stylus fashion by transversing the media. This allowed for low cost and relatively low spring force due to the small surface area that the ball or micro wheel (typically 2 to 3 mm diameter) contacted on the media. The disadvantage of this method was that the processing pitch required to ensure uniform development needs to be (approximately 1 mm for a 3/16″ diameter ball) which results in slow processing times for a typical print image format (4×6 inch). Ganging multiple ball stylus or micro wheels adds cost, and increases the possibility of processing failure due to debris caught under a ball surface.

Conventional high speed processing involved line processing utilizing large crushing rollers. To ensure the high pressure, (psi) required, these rollers tended to be large to minimize deflection. However, these large rollers were costly, heavy, and require high spring loading. Again, the extensibility of this method is limited as larger rollers (and spring loads) are required as media size increases.

Furthermore, the photohardenable composition in at least one and possibly all three sets of microcapsules can be sensitized by a photo-initiator as noted above such as a cationic dye-borate complex as described in, for example, U.S. Pat. Nos. 4,772,541; 4,772,530; 4,800,149; 4,842,980; 4,865,942; 5,057,393; 5,100,755 and 5,783,353. Because the cationic dye-borate anion complexes absorb at wavelengths greater than 400 nm, they are colored and the unexposed dye complex present in the microcapsules in the non-image areas can cause undesired coloration in the background area of the final print or picture. That is, the print typically exhibits an obvious overall coloration caused by the residual photo-initiator. Typically, the mixture of microcapsules is greenish and can give the background areas a greenish tint. Although exposure to room light will serve to bleach out the photo-initiator over time, the print quality immediately after processing could appear to be of poor quality.

It is also noted that recent developments in media design (or the imaging member) as described in co-pending U.S. application Ser. No. 10/687,939 have changed the prior art structure of the imaging member to the point where the aforementioned means of processing may no longer be robust. The use of a substantially non-compressible top clear polymer film layer and a rigid opaque backing layer which serves to contain the image forming layer of conventional media presented a processing position whereby balls, micro wheels or rollers could be used without processing artifacts such as scratch, banding, or dimensional or surface deformation. In addition, the non-compressibility of this prior art structure provided more tolerance to processing conditions.

The recent imaging member embodiment as described in the above-mentioned co-pending patent application, replaces the top and bottom structures of the media with highly elastic and compressible materials (gel SOC) (super over coat or top most clear gel comprising layer) and synthetic paper (polyolefin). The media as described in the above-mentioned co-pending application no longer survive these means of processing in a robust fashion where pressure is applied by a roller or ball. This is due to the fact that in the imaging member described in the co-pending application, the polyolefin paper backing that is used as fiber base substrates (cellulose fiber) present non uniform density, and the high compression forces required for processing in the conventional arrangements may make an “image” of the fiber pattern in the print, thus making the print corrupt.

Further, conventional image forming devices may include exposure systems that enable a large area exposure of microencapsulated media by utilizing a monochromatic LCD (Liquid Crystal Diode) projection system. The conventional monochromatic LCD projection system comprises a three-color (RGB) filter wheel. Prior limitations of this technology were the size of the device (large lamp due to exposure energy requirements), the additional mechanical parts for the filter wheel assembly, and the poor throughput of images due to the need of rotating and imaging the file through three filters.

U.S. Pat. No. 5,512,967 describes an LCD projection system that does not use a three color filter wheel and its related mechanical components. Although a reasonable facsimile of the image file could be generated by exposure to the LCD projector as described in this patent, the print suffered image artifacts caused by the “read out” of the grid lines inherent to the LCD's. In application as a projector, this artifact “screen door effect” is not objectionable due to the intended projected image. However, a sampling of this effect imaged on a small format print (4×6 inches) is highly objectionable, and results in a poor quality image.

It would be advantageous to provide a means of large area exposure to allow for “page printing” while minimizing or eliminating artifacts. Page printing is defined as the ability to completely and simultaneously expose the print area surface. This ability would further be enabled if the intensity of the exposing source was sufficient to permit sub-second exposure times. Furthermore, joining this means of exposure to the processing means of commonly assigned co-pending U.S. application Ser. No. 10/722,248 filed Nov. 25, 2003, would allow for a high speed rapid access means of obtaining prints.

It would be further advantageous to provide a means or method of processing that did not invoke present methods utilizing high compression forces to provide a high quality image by improving the tonal scale development and density minimum formation of the imaging member. In addition, a processing means that would use plain paper as a substrate would be highly desired. Further, it would be advantageous to provide a means of processing that is low in cost, is fully extensible, is mechanically simple and robust, and can minimize undesired coloration in the developed image.

### SUMMARY OF THE INVENTION

The present invention addresses the above noted drawbacks by providing for an image forming device having an exposure member that enables simultaneous exposure of an image through a 3-color LCD device.

In an embodiment of the image forming device of the present invention, a developing roller that includes a plurality of micro-members thereon can be utilized. The micro-members provide for a compliant surface, which can be non-uniform, is self-correcting for unintentional media thickness variations within a print area, and employs shear-like forces more so than compression forces or a combination thereof for development. The use of the micro-members restricts the processing development to the image-forming layer of the media, leaving both the top-most clear gel comprising layer intact and without scratches. Further, the roller of the present invention having the micro-members does not invade the bottom-most backing layer of the media and thus avoids pattern read out of low cost supports. The roller having micro members in accordance with the present invention essentially resembles a brush and thus can be referred to as a brush roller.

The embodiment of image-forming device of the present invention that includes the brush roller is fully extensible for all printer applications and is low cost. The composition of the micro members or brushes of the brush roller of the present invention can be varied; for example, where a polymer can be used since it provides a soft contact surface, elasticity, and resiliency, however, any natural or synthetic material meeting these criteria can be employed as the micro-members or brush.

The present invention therefore relates to an image forming device that comprises an exposure member adapted to expose a photosensitive medium to form a latent image on the photosensitive medium, with the exposure member comprising a light source, a first lens provided in a light path of light from the light source, a shutter provided in the path and a media locating member adapted to locate the photosensitive medium to be exposed at a focused position along the light path relative to the light source, and the photosensitive medium comprising a plurality of microcapsules which encapsulate imaging material; and a processing member adapted to develop the latent image by contacting the photosensitive medium with a force that is sufficient to release imaging material from selected microcapsules.

The present invention further relates to an image forming method that comprises the steps of (i) exposing a photosensitive medium comprising a plurality of microcapsules that encapsulate imaging material to form a latent image; with the exposing step comprising: a) placing the photosensitive medium in front of a light exposure source having a shutter that permits controlled exposure of the media; b) placing a first lens between the light exposure source and the photosensitive medium; and c) exposing the medium by providing light from the light source along a light path that passes through the lens; and (ii) developing the latent image by contacting a surface of the medium with a processing member that is adapted to apply a force to the surface of the medium which is sufficient to release imaging material from the microcapsules.

### BRIEF DESCRIPTION OF THE DRAWINGS

FIG. 1A schematically shows an image-forming device;

FIG. 1B schematically shows an example of a pressure applying system that can be used in the image-forming device of FIG. 1;

FIG. 1C is a schematic view of an embodiment of an image forming device in accordance with the present invention;

FIG. 1D is a further embodiment of the device of FIG. 1C;

FIG. 1E is a schematic representation of an exposure member or projection system in accordance with a feature of the present invention;

FIG. 1F illustrates a turret for holding at least two lenses which can be used in the exposure member of FIG. 1E;

FIG. 1G is a detailed view of the projector of FIG. 1E;

FIG. 2 schematically shows an image-forming device in accordance with the present invention;

FIG. 3 shows a processing roller of the image-forming device of FIG. 2;

FIG. 4 is a perspective view of an image-forming device of the present invention;

FIG. 5 is a perspective view of the image-forming device of FIG. 4, illustrating a backing member;

FIG. 6 is a further embodiment of an image-forming device in accordance with the present invention;

FIG. 7 is a further embodiment of an image-forming device in accordance with the present invention;

FIG. 8 is a further embodiment of an image-forming device in accordance with the present invention;

FIG. 9 is a further embodiment of an image-forming device in accordance with the present invention; and

FIG. 10 schematically illustrates a processing system/method in accordance with a feature of the invention.

### DETAILED DESCRIPTION OF THE INVENTION

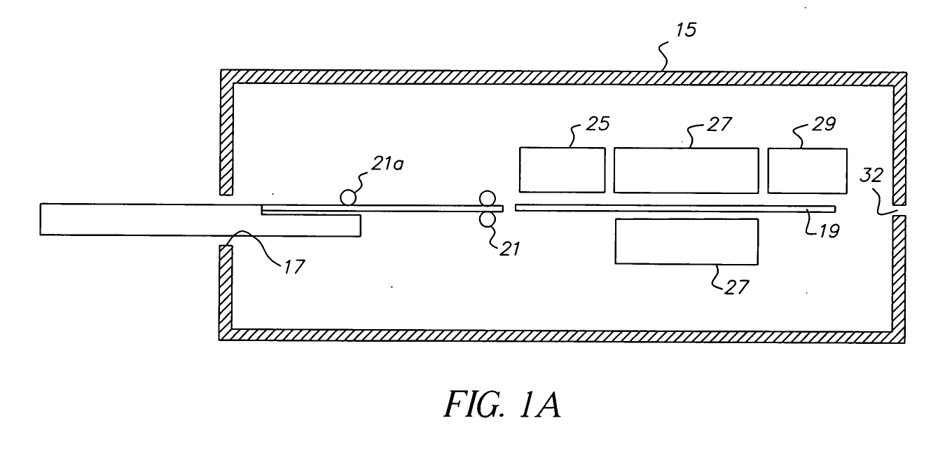

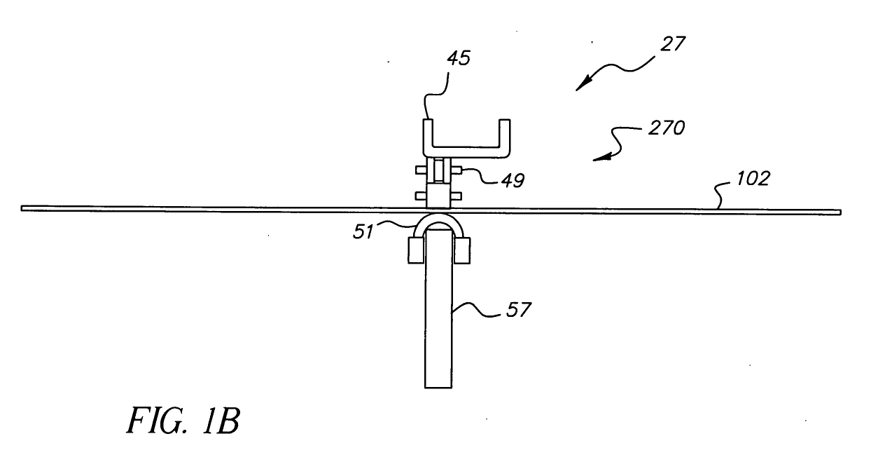

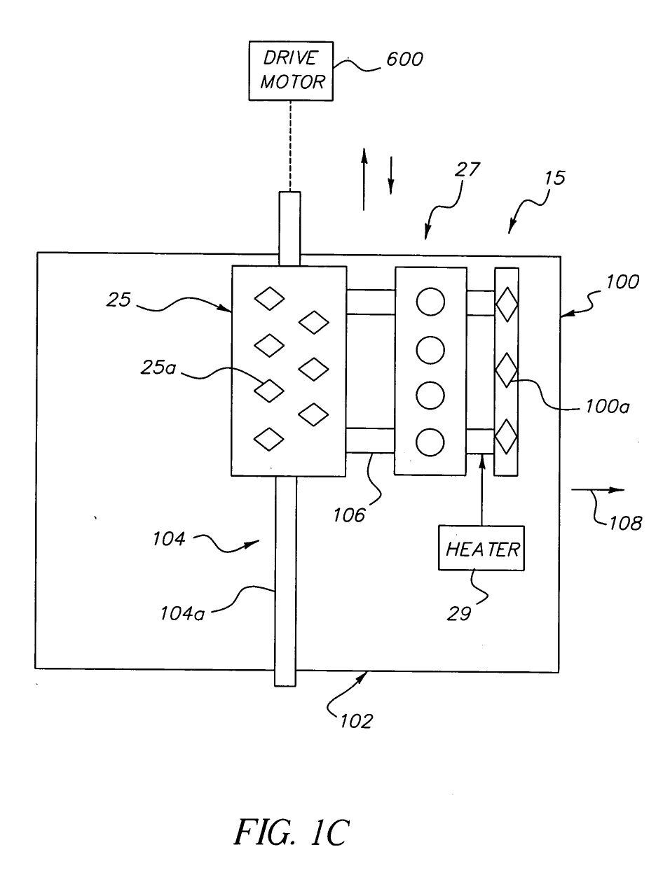

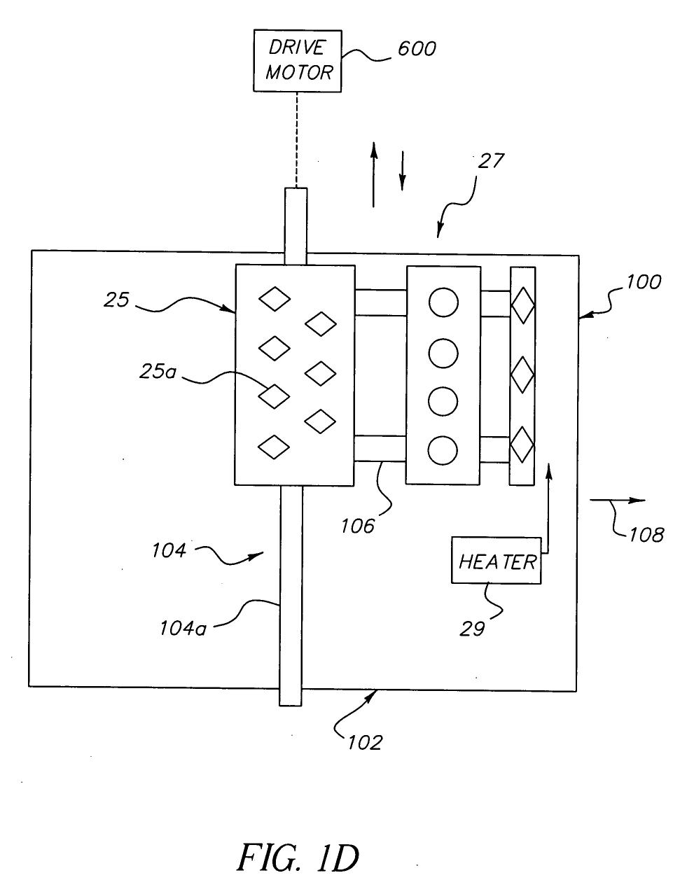

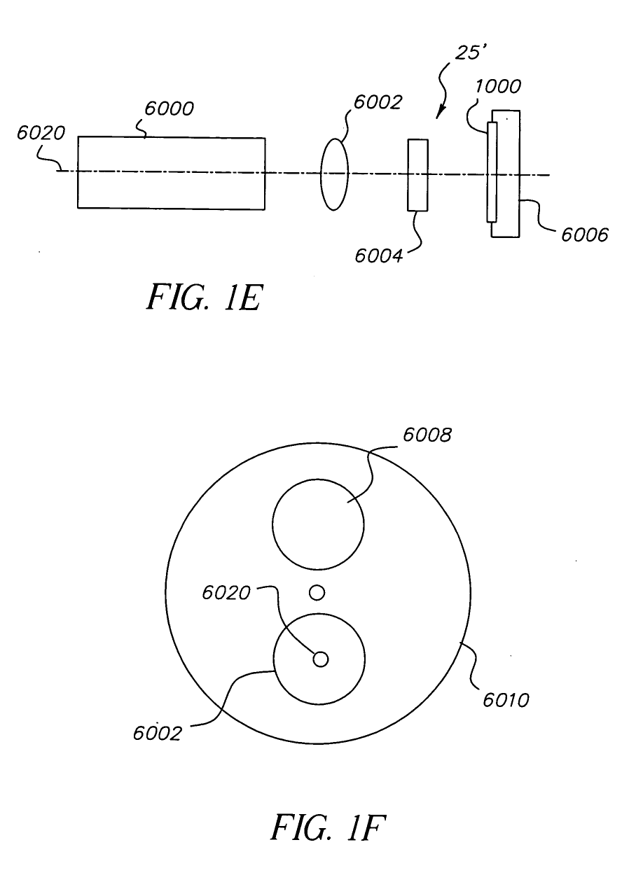

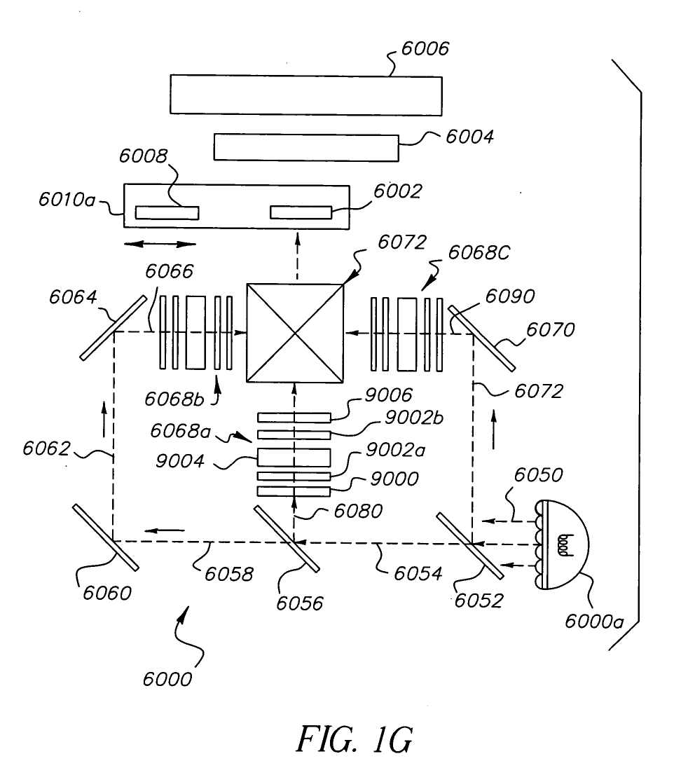

Referring now to the drawings, wherein like reference numerals represent identical or corresponding parts throughout the several views, FIG. 1A is a schematic view of an image-forming device 15 pertinent to the present invention. Image forming device 15 could be, for example, a printer that includes an opening 17 which is adapted to receive a cartridge containing photosensitive media. As described in U.S. Pat. No. 5,884,114, the cartridge could be a light tight cartridge in which photosensitive sheets are piled one on top of each other. When inserted into image forming device 15, a feed mechanism which includes, for example, a feed roller 21 a in image forming device 15, working in combination with a mechanism in the cartridge, cooperate with each other to pull one sheet at a time from the cartridge into image forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image forming device 15, photosensitive media travels along media path 19, and is transported by, for example, drive rollers 21 connected to, for example, a driving mechanism such as a motor. The photosensitive media will pass by an exposure or imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator or pressure assembly, wherein an image such as a color image is formed based on the image information by applying pressure to microcapsules having imaging material encapsulated therein to crush the microcapsules. The pressure could be applied by way of spring-loaded balls, micro wheels, micro rollers, rolling pins, etc.

FIG. 1B schematically illustrates an example of a pressure applicator 270 for processing assembly 27 which can be used in the image-forming device of FIG. 1A. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush microcapsules and release coloring material. Further examples of pressure applicators or crushing members which can be used in the image-forming device of FIG. 1A are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

As shown in FIG. 1C, in a first feature of the present invention, exposure or imaging member 25 as well as processing assembly 27 are mounted on a movement device 104 associated with a drive motor 600 or an equivalent drive device. Movement device 104 in cooperation with motor 600 are adapted to move imaging member 25 and processing assembly 27 as a unit in a direction transverse to a conveying direction 108 of media 102 so as to scan media 102. Due to residual photoinitiators as discussed above and in co-pending U.S. application Ser. No. 10/621,785, the contents of which are herein incorporated by reference, the print may include an undesired overall coloration. As illustrated in FIG. 1C, in a first embodiment of the present invention, image-forming device 15 includes non-imaging member 100 in the form of a second LED exposure head. In the embodiment of FIG. 1C, non-imaging member 100 is located downstream of processing assembly 27 with respect to direction of travel 108 of media 102 and is also mounted on movement device 104. Movement device 104 could comprise a support structure 106 and a rotatably mounted motor driven lead screw 104a or some other type of linear conveying mechanism such as belts, gears, racks, etc. that is adapted to support and drive imaging member 25, processing assembly 27 and non-imaging member 100 as a unit. Upon actuation of movement device 104 all three members 25, 27, 100 move as a unit in a direction transverse to moving direction 108 of media 102.

Therefore, during use of the embodiment of FIG. 1C, after media 112 passes processing assembly 27 it is conveyed past non-imaging member 100. Non-imaging member 100 which is constructed as an LED print head that comprises at least one R, G and B LED 100a is adapted to direct a visible light beam or non-visible energy (depending on the nature of the photoinitiator) onto the exposed and developed media. Therefore, as one example, the LEDs or energy source could be of the type that emits visible light from red, green and blue emitting sources. As an example, the system could be 638 nm red, 525 nm green and 450 nm blue, however, the present invention is not limited to these values and other values that are adapted to emit visible red, green and blue light can be used. As an alternative option, depending on the nature of the photoinitiator, the LED's or energy source could be adapted to emit non-visible energy.

The photons from the LEDs of non-imaging member 100 cause the release of radicals which accordingly causes a reduction of the photoinitiators and thus serves to bleach out the photoinitiators. This therefore eliminates the undesired coloration described above while leaving the dye image intact. Further, since non-imaging member 100 is not utilized as an image-forming device, non-imaging member 100 does not require modulation or spot shaping. An advantage of the structure of FIG. 1C is that all of the elements (imaging member 25, processing assembly 27 and non-imaging member 100) are mounted for movement as a unit. This eliminates the need for extra movement members and helps to synchronize the movement of all three elements.

Further, the application of heat by heater 29 could occur prior to the photobleaching step as shown in FIGS. 1A and 1C or after the photobleach step as shown in FIG. 1D. Essentially, in one embodiment of the invention, the process involves a sequence as shown in FIGS. 1A and 1C that includes an exposure step (through LEDs 25a of imaging member 25), a hold step, a crushing or pressure applying step (processing assembly 27), a hold step, a post heat step (heater 29) and a photobleach step (non-imaging member 100). However, the present invention is not limited to this sequence and it is recognized that the photobleach step can occur before the post heat step as shown in FIG. 1D. The embodiment of FIG. 1D is similar to the embodiment of FIG. 1C with the position heater 29 and non-imaging member 100 being reversed from the position of FIG. 1C. Therefore, in FIG. 1D, after the media is conveyed past processing assembly 27 it undertakes a photobleaching by non-imaging member 100 and thereafter a post heating by heater 29 occurs.

FIG. 1E illustrates an example of an exposure or imaging member 25′ which can be utilized in an embodiment of the present invention. Exposure member 25′ can involve the use of a 3 LCD system, each LCD with either a red, green, or blue filter, and one compact lamp that is adapted to illuminate all three LCD's. Exposure member 25′ comprises a projector 6000 that includes or forms a part of a light source or a compact lamp, a lens 6002, a shutter 6004 and a media locating member 6006 which can be in the form of a vacuum easel. Although a single lens 6002 is shown, exposure member 25′ can include a turret 6010 or a linear sliding mechanism 6010a (FIG. 1G) that contains lens 6002 for printing on media of a first size and a second lens 6008 for printing on media of a second size. Exposure member 25′ is adapted to image a light beam along a light path or optical axis 6020 so as to expose media located on locating member 6006. If a turret is used as shown in FIG. 1F, the turret can be rotatable between at least a position as shown in FIG. 1F that places lens 6002 at optical axis or light path 6020 and a second position that places lens 6008 at optical axis or light path 6020. A sliding mechanism 6010a would provide the same result by moving between a position where lens 6002 is at the optical axis and a position where lens 6008 is at the optical axis. Further, as shown in FIG. 1E, the elements of exposure member 25′ are preferably located in an in-line relationship along light path or axis 6020. With exposure member 25′, simultaneous exposure of the image through a 3-color LCD system allows for greatly improved exposing throughput.

With regard to features of the projector of the exposure member of the present invention, it is known that digital projectors use a computer chip with hundreds of thousands of miniature mirrors that can be tilted under computer control. The tilting of the mirrors changes the amount of light reflected onto the image. These mirrors can typically be tilted faster than the pixels in an LCD display, but this design can produce some unexpected effects on motion video.

These projectors will either use three separate DLP (Digital Light Projectors or Processing) chips (one for each color) and a set of prisms and mirrors to combine the three sets of pixels, or just one DLP chip and a spinning color wheel with three color filters to create the same effect. In either case, the result is that each pixel is made up of only one square, since the three colors are mixed together. This produces a less pixilated image than found on an LCD projector, but the use of a spinning wheel may sometimes create a “rainbow” effect, the result of some shimmering in the image that some viewers might see as similar to a slow CRT refresh rate. (The faster the speed of the wheel, the less of a problem this will be.)

In the present invention, lens 6002 was designed and placed in the optical path 6020 of the projector 6000 to minimize the image, thus making it suitable for typical print formats, while removing the appearance of the screen door effect discussed above. This had the additional benefit of improving the light intensity (reverse inverse square law) and allowed for sub second exposures.

A commercially available projector such as (but not limited to) PROXIMA Model C 180 can be utilized in the present invention. Such a projector can include a 4:3 native aspect ratio; a contrast ratio of 400:1; three 0.79″ polysilicon TFT LCD active matrixs; a 170 Watt UHP lamp; a 2200 ANSI lumens. This arrangement provides for both improved color rendition and short print exposure times (< 3/10ths of a second simultaneous RGB exposure resulting in a 4×6 inch print) for visible light sensitive microencapsulated media having an approximate ASA speed of 0.003.

FIG. 1G illustrates a more detailed view of projector 6000. As shown in FIG. 1G, projector 6000 includes a light source or lamp 6000a that applies a white light 6050 to a first dichroic mirror 6052. First mirror 6052 reflects blue light 6072 to a second dichroic mirror 6070 and permits a transmission of red and green light 6054 to a third dichroic mirror 6056. Third mirror 6056 reflects green light 6080 to a first light valve 6068a and transmits red light 6058 to a fourth dichroic mirror 6060. Fourth mirror 6060 reflects red light 6062 to a fifth diohroic mirror 6064 which in turn reflects red light 6066 to a second light valve 6068b. Second mirror 6070 reflects blue light 6090 to a third light valve 6068c.

Each of light valves 6068a, 6068b and 6068c are known light valves; wherein each light valve 6068a, 6068b, 6068c comprises an incoming polarizer 9000, a first LCD compensation filter 9002a, a LCD 9004, a second LCD compensation filter 9002b and an outgoing polarizer 9006, such that each element is located in an in-line relationship with respect to the direction of movement of light. Light valve 6068a applies modulated green light to a combining cube 6072; light valve 6068b applies modulated red light to combining cube 6072; and light valve 6068c applies modulated blue light to cube 6072. Thereafter, the modulated light from each of the light valves are combined and applied to either lens 6002 or 6008 of sliding lens mechanism 6010a, depending on the position of lens mechanism 6010a. The lens mechanism can either be a turret as shown in FIG. 1F or a linearly mounted sliding mechanism as shown in FIG. 1G. As previously described, sliding mechanism 6010a has lenses 6008 and 6002 mounted thereon and is adapted to move between positions where the appropriate lens 6002, 6008 is in front of the combined light path. After passing through lens mechanism 6010a, the light passes through shutter 6004 and onto media locating member 6006 as described with reference to FIG. 1E.

As previously discussed, conventional arrangements employ spring loaded micro-wheels or ball processing (point processing) to provide a pressure or crushing force to microcapsules of microencapsulated media. The traditional approach for crushing the microcapsules by way of a crushing force applied by balls, wheels or micro-rollers may provide for processing speeds which are in some instances not as fast as desired due to the fact that the development pitch of these arrangements are small, and processing velocity is limited to reasonable by-directional travel rates. Furthermore, in the traditional ball-crushing arrangements, debris introduced into the printer can cause the ball or microwheel to drag the debris over the media to cause a scratching of the image and, thus, render the print unusable.

In order to provide for a higher throughput device, large rollers, which have a width that covers the width of the media, can be utilized. However, these large rollers tend to have a non-compliant surface and will not compensate for imperfections or undulations in the media and, thus, results in poor processing. Further, if debris is carried by the large rollers, poor processing is also achieved.

Also, as discussed above, media substrates prone to deformation under the pressure load for development (typically 100 MpA) can jam in the device or irreversibly deform thus rendering the print unusable. In addition, debris entering the processing nip between rollers can cause damage to the roller rendering the processing means unusable.

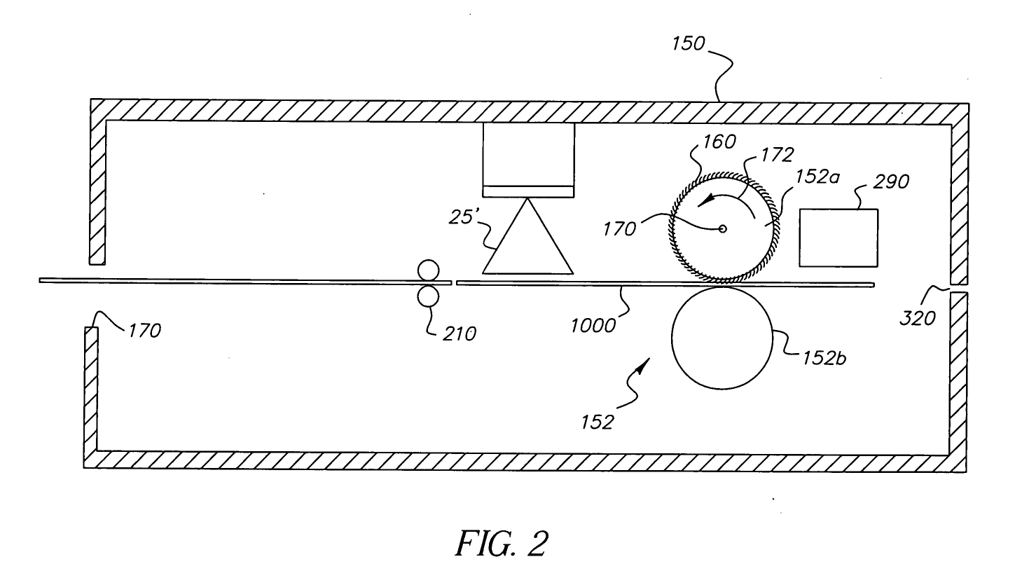

In an embodiment of the present invention, an image-forming device 150 as shown in FIG. 2 can be used. Image-forming device 150 is similar to image-forming device 15 in FIG. 1 except for the processing member. More specifically, image-forming device 150 can be adapted to accept microencapsulated media through an opening 170, while a roller 210 can be adapted to convey the media to an imaging member 250. Exposure or imaging member 25′ can be an imaging head that includes a plurality of light-emitting elements adapted to expose a latent image on the media based on image information and can be designed as shown in FIG. 15E and described above. After the latent image is formed, the media is conveyed passed a processing assembly or a development member 152 in accordance with the present invention. Development member 152 comprises a roller 152a and a backing member 152b, which can be an opposing roller, an opposing beam or a surface having a width that generally matches the width of the media. Roller 152a includes a compliant outer surface, which is adapted to contact microencapsulated photosensitive medium 1000 when it travels between roller 152a and backing member 152b. More specifically, roller 152a includes a surface which comprises a plurality of micro-members 160. In a preferred embodiment, micro-members 160 are hook-like or loop-like members provided on the exterior surface of roller 152a. Hook or loop-like members 160 define an outer surface of roller 152a which is compliant and can be non-uniform. With this arrangement, roller 152a essentially resembles a brush and can also be referred to as a brush roller.

For processing media, roller 152a is rotated or spins about a center axis 170 in direction 172, such that micro-members 160, for example, the hooks or loop-like members, contact media 1000 with a rotational or spinning force so as to apply a shear-like force and/or a compressional force onto the top surface of media 1000. With this arrangement, the rotational force applied by micro-members 160 is essentially converted to a compressive or pressure force onto media 1000, which is sufficient to rupture the microcapsules. More specifically, micro-members 160 can be in the form of, for example, plastic loop or hook-like members that are randomly or predeterminedly provided on the outer surface of roller 152a and have random or predetermined heights and locations. The loop or hook-like members 160 provide sufficient force to rupture the capsules. Further, a random positioning in height of hook or loop-like members 160 allow for uniform development of non-uniform media thickness as the plurality of hook or loop-like members 160 impinge on the media and become self-correcting to adapt to media thickness variations.

In a further aspect of the invention, each of the separate loop or hook-like members 160 essentially form a nip-like area with backing member 152b when media 1000 passes there-between. As noted above, micro-members 160 can be plastic. However, the present invention is not limited thereto. It is noted that micro-members 160 can be made of a fiber material or synthetic material. Further, rather than hooks and loops, the outer surface of roller 152a can be a coated cloth. Essentially, outer surface of roller 152a should preferably define a compliant surface that can be non-uniform.

In a feature of the present invention, spinning roller 152a with micro-members 160 thereon is sufficient to restrict the processing development to the image forming layer of media 1000, while leaving both the top most clear gel comprising layer intact and without scratches. Further, roller 152a with micro-members 160 thereon does not invade the bottom-most backing layer of media 1000 and thus, avoids pattern readout of low-cost media supports.

In the embodiment of FIG. 2, roller 152a has a width that generally matches the width of media 1000 and therefore, is effective to crush all the unhardened microcapsules and release imaging material to form an image. The imaging material that is released from the microcapsules comprises a coloring material which is used to form the image or material for black and white media. After formation of the image, the photosensitive media is conveyed pass heater 290 for fixing the image on the media. In a through-feed unit, the photosensitive media could thereafter be withdrawn through an exit 320. As a further option, image-forming device 150 can be a return unit in which the photosensitive media is conveyed to or returned back to opening 170.

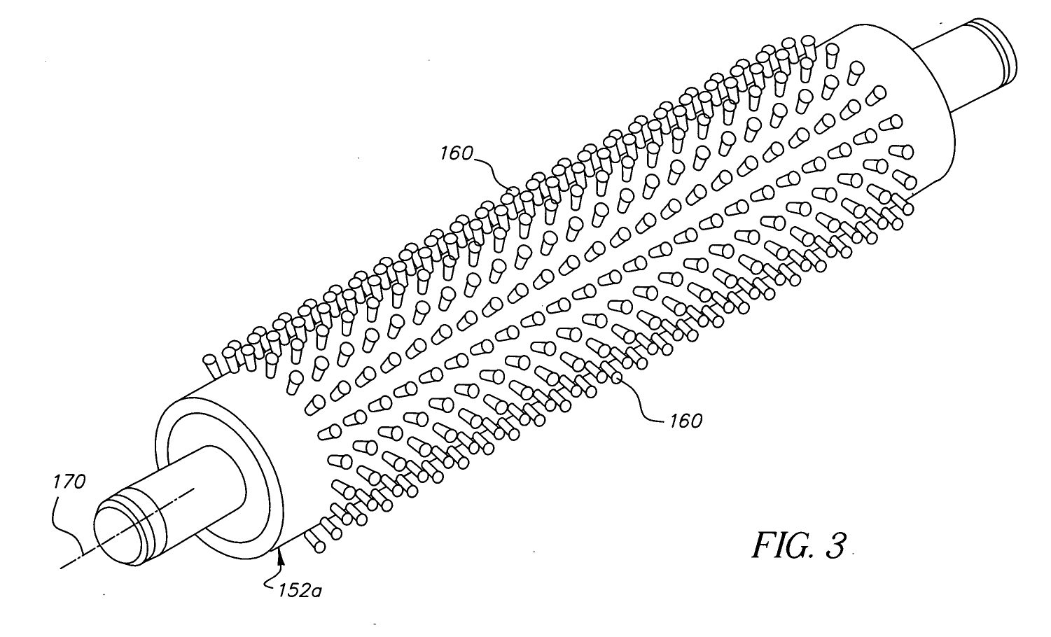

FIG. 3 is a more detailed view of roller 152a and micro-members 160 on roller 152a. As shown, roller 152a can be a tubular member that has an outer surface with plurality of micro-members 160 thereon. In the embodiment of FIG. 3 micro-members 160 are hook-like or loop-like members, which can be made of a plastic or resilient material. Additionally, as further described above, micromembers 160 can be provided on the outer surface of roller member 152a in a random or predetermined pattern with respect to location and height. The multiple loop or hook-like members 160 on roller member 152a essentially define an outer compliant surface for roller 152a, which compensates for any non-uniform surfaces of the media. In essence, roller 152a is self-correcting for media thickness variations and each of the hook or loop-like members 160 define a nip-like area with the opposing surface of backing member 152b that permits the passage of media therebetween while at the same time developing the image on the media. Further, any dust, dirt or debris which enters into a vicinity of roller 152a will not get caught onto the outer surface of roller 152a, since the outer surface of roller 152a comprises the multiple loop or hook-like members 160 which will not trap the dust or debris therein. Further, the spinning motion of hook or loop-like members 160 will tend to clear away any dust or dirt within the vicinity of roller 152a.

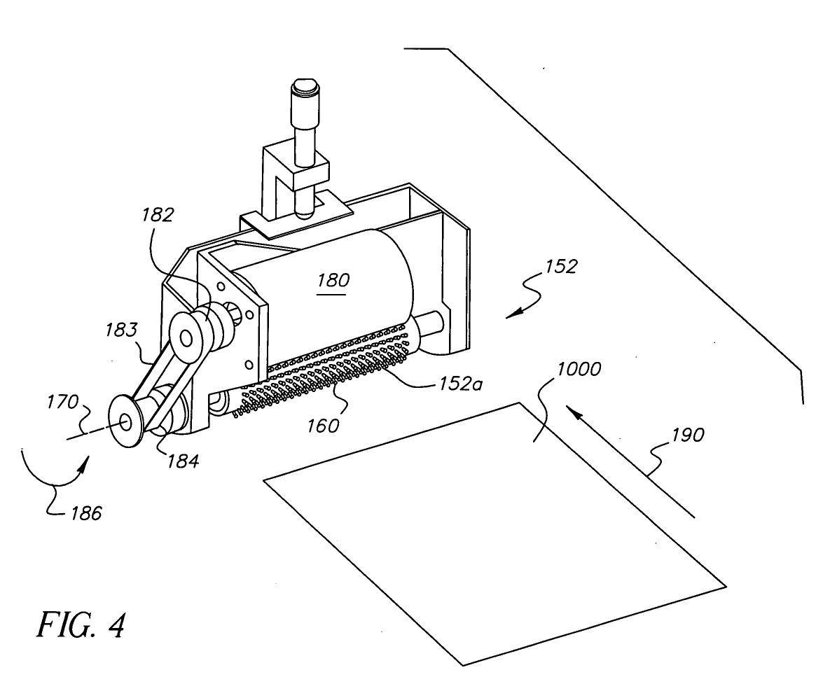

FIG. 4 is a perspective view of development member 152 of imaging device 150 of the present invention. As illustrated and described, development member 152 includes roller 152a having loop or hook-like members 160 thereon. A first example for rotating roller 152a to achieve development of the latent image on media 1000 is through the use of a motor 180, which drives a shaft 182, which accordingly drives a drive belt 183. Drive belt 183 is drivingly associated with a shaft 184 of roller 152a. In the example of FIG. 4, rotational motion of motor 180 in a first direction will cause a subsequent rotation or spinning of roller 152a in direction 186 around center axis 170. In the example of FIG. 4, media 1000 approaches development member 152 in direction 190 and passes between roller 152a and backing member 152b illustrated in FIG. 2. The rotational force of roller 152a causes loop or hook-like members 160 to contact the top surface of media 1000 with a spinning or shearing motion that essentially is converted to a pressure on media 1000 to cause a rupture of the non-hardened microcapsules to release coloring material. This rotating motion, however, will not cause a scratching of the surface of media 1000. In a preferred embodiment, in order to assure development of the image, the media moves at a line velocity which is different from the spinning velocity of roller 152a to ensure a shearing action. Also, roller 152a can spin or rotate at various velocities in accordance with design considerations, however, faster velocities provide for a higher probability of more micro-members 160 striking the microcapsules on the media, which improves development.

Further, although roller 152a is shown as spinning in a direction opposite to the direction of movement of media 1000, the present invention is not limited thereto. Roller 152a can also spin in the direction of movement of media 1000 or tangentially to the direction of movement of media 1000.

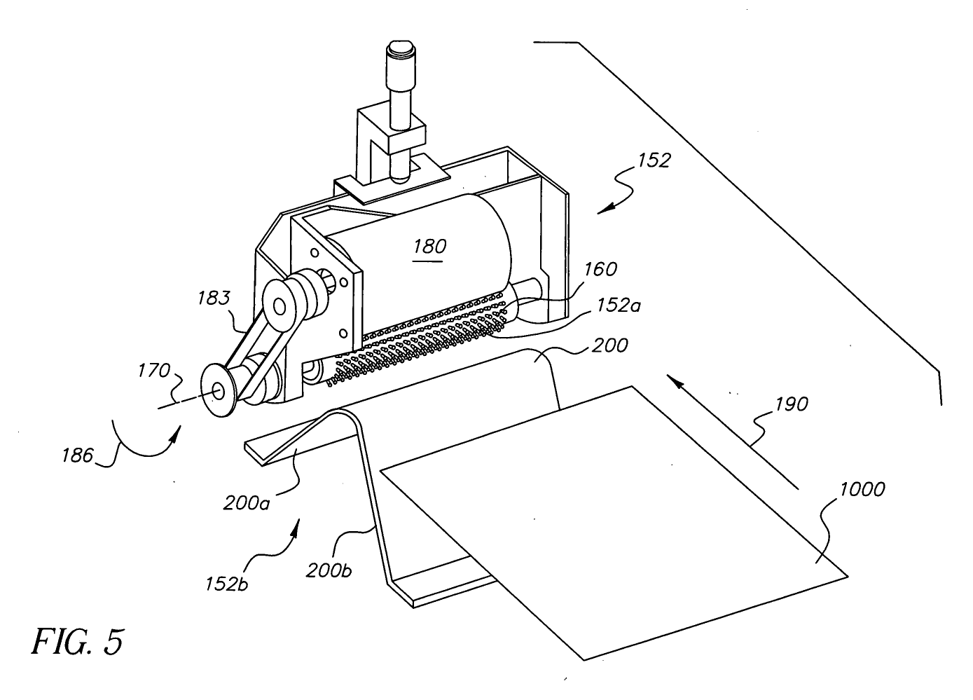

FIG. 5 is a perspective view of an embodiment of imaging device 150 and specifically, an embodiment illustrating roller 152a and backing member 152b of processing member 152. In the embodiment of FIG. 5, backing member 152b preferably comprises a surface 200 which opposes roller 152. Surface 200 is supported by opposing legs 200a, 200b. In this manner, when hook or loop-like members 160 of spinning roller 152a contact media 1000 passing between roller 152a and surface 200, the compliant character of roller 152a will compensate for any non-uniformities in media 1000. The spinning or rotating motion of roller 152a and the contacting of loop or hook-like members 160 onto the surface of media 1000 develop the image on media 1000. Further, in the embodiment of FIG. 5 surface 200 can be provided on flexible legs 200a, 200b to further add to the flexible nature of the arrangement. Also, as previously discussed, backing member 152b can alternatively be a roller that opposes roller 152a.

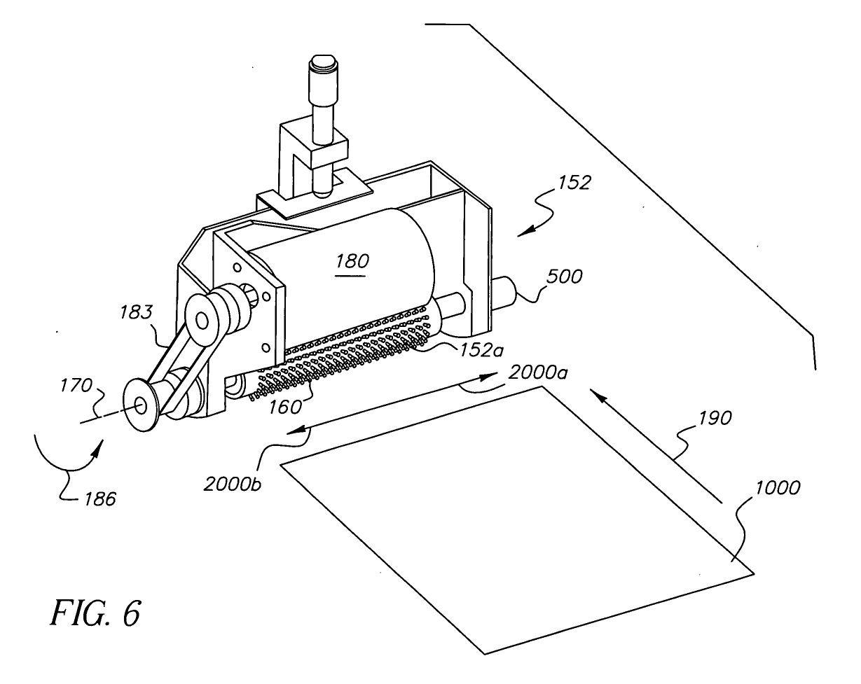

FIG. 6 illustrates a further embodiment of imaging device 150 of the present invention. In the embodiment of FIG. 6, in addition to spinning or rotating roller 152a about axis 170, roller 152a can be moved or reciprocated transversely in directions 2000a, 2000b that are perpendicular to the direction of movement 190 of media 1000. The embodiment of FIG. 6 enhances the contacting of hook or loop-like members 160 on the surface media 1000 by both spinning and reciprocating roller 152a to insure a complete development of the image on media 1000. In the embodiment of FIG. 6, linear or reciprocating motion of roller 152a could be achieved by a moving member, moving device or motor 500 attached to, for example, a pneumatic member, which is adapted to linearly move and reciprocate roller 152a. As a further option, roller 152a could be associated with a rack gear that would be drivingly connected to motor 180 or motor 500 through, for example, a gear train to cause the linear and reciprocating movement.

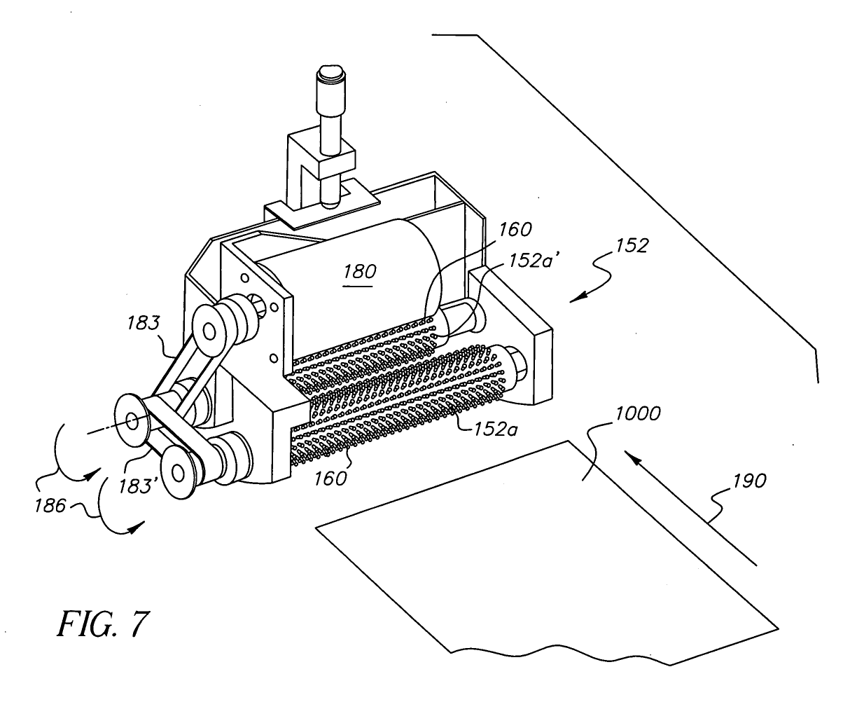

The embodiment of FIG. 7 is designed to maximize the locational density of the loop or hook-like members of the roller of developing member 152. More specifically,.in the embodiment of FIG. 7, roller 152a as well as an additional roller 152a′ slightly offset from roller 152a is shown. Each of rollers 152a and 152a′ have hook or loop-like members 160 on an outer surface thereof. This arrangement maximizes the amount of hooks or loops that contact media 1000 as media 1000 passes below rollers 152a, 152a′. In the embodiment of FIG. 7, both rollers 152a, 152a′ rotate or spin in direction 186 as shown, wherein the rotation can be enabled through the use of conveyer belts 183, 183′ or a gear train to drive both rollers 152a, 152a′.

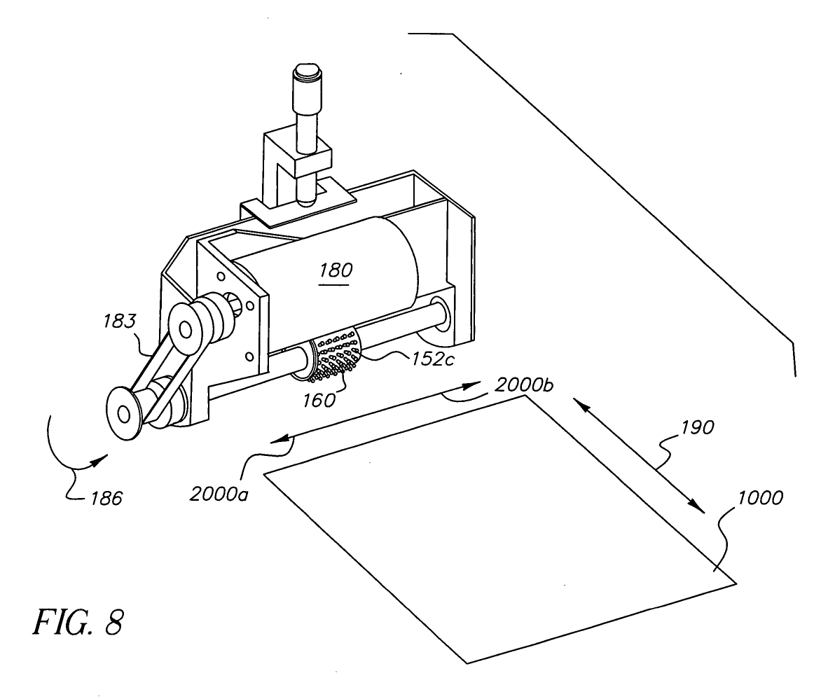

In the previous embodiments, the size of rollers 152a, 152a′ basically matched the width of the media. In a further embodiment, the roller can be a small size roller 152c as shown in FIG. 8. Small size roller 152c can be adapted to move or reciprocate transversely in the directions 2000a, 2000b perpendicular to direction of movement 190 of media 1000. This linear movement can be caused by any type of linear movement mechanism or arrangement as previously described, such as a pneumatic cylinder, a gear arrangement, a rack gear, a helical gear, etc. Small size roller 152c is the same as roller 152a with respect to having an outer surface with micromembers such as loop or hook-like members as shown.

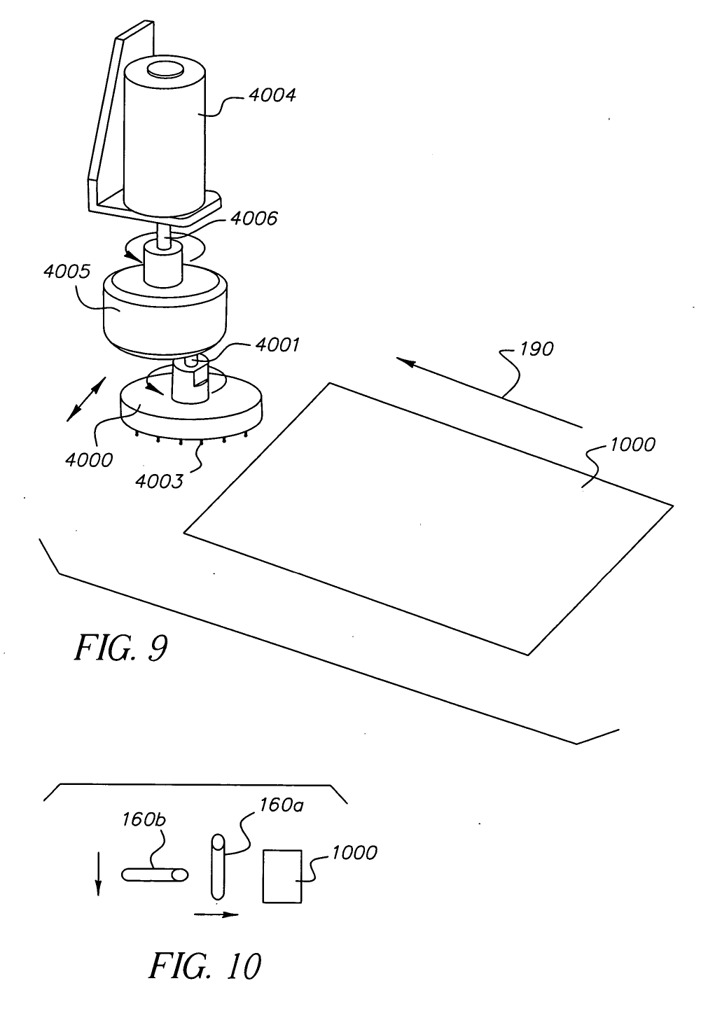

FIG. 9 illustrates a further embodiment of a development member in accordance with the present invention. In the previous embodiments, the rollers rotated about a horizontal axis 170, which is perpendicular to the direction of movement of the media. In the embodiment of FIG. 9, the development or processing member is in the form of a plate-like member 4000, which rotates or spins about a vertical axis 4001, which is perpendicular to direction of movement 190′ of media 1000 as shown. In the embodiment of FIG. 9, plate-like member 4000 includes nrotruding micro-members 4003 which can be plastic or resilient hook or loop-like members that extend from the bottom surface of member 4000. Also shown is a motor 4004, which is adapted to rotate an eccentric-like intermediate member 4005, which is adapted to move plate member 4000 and shaft 4001 about a further axis 4006, and is further adapted to rotate plate member 4000 about axis 4001. Therefore, with the embodiment of FIG. 9, media 1000 can move below member 4000 as member 4000 is rotated and transversely moved. That is, member 4000 can both spin about center axis 4001 and also moves transversely about second axis offset from axis 4001. This assures a complete processing of the microcapsules as micro-member 4003 contacts the surface of media 1000.

Accordingly, the above embodiments provide for an improved imaging device wherein a processing roller or member in the form of, for example, a brush roller is rotated or spun and brought into contact with the top surface of micro-encapsulated media. The roller includes micromembers such as loop or hook-like member, which come into contact with the media and convert the rotational or spinning motion into a pressure that is sufficient to rupture the microcapsules. The brush roller of the present invention achieves a Dmax (maximum density), which is improved over the Dmax of, for example, a conventional ball-like pressure-type roller.

The arrangement of the present invention is advantageous for processing media such as disclosed in co-pending application U.S. Ser. No. 10/687,939, since the plastic or resilient loop or hook-like member provide a sufficient force to rupture the capsules, while the random position and height of the loop or hook-like members allow for uniform development of non-uniform media thickness. Further, the roller is self-correcting due to a compliant surface. With the arrangement of the present invention, there is no need for a high spring force or a large roller with high hardness.

The present invention also permits the use of a low cost base media since the processing is restricted to the microcapsules and any deformation or patterning caused by density differences in the support sheet and read out in the development of the media due to the resulting differential pressures is of no consequence. Further, the roller is self-cleaning since debris cannot damage the loop or hook-like members, and the roller effectively removes the debris from the print surface during processing.

As discussed above, in a further feature of the present invention, an exposure of the latent image prior to the processing of the image involves using exposure member 25′ and placing media 1000 in front of the projector 6000, where shutter 6004 placed between the projector 6000 and the media 1000 allows controlled times of exposure. The media 1000 is maintained at a specified “in focus” relationship to the projected image source from projector 6000 by distance through the use of locating member 6006 in the form of, for example, a vacuum easel.

The latent image on the media can be developed or processed by either crushing (nominal 10,000 psi large 4″ crushing wheel) or by brush processing depending if the media exposed was plastic substrate or paper substrate respectively.

The processed media for both cases, can be heat treated at 90 C for 10 seconds to ensure complete dye yield and finally photobleached at 88Klux for 5 seconds to ensure removal of any residual photinitiators.

With the arrangement of the present invention, an effective exposure of the media is realized. Further, placement of lens 6002 or 6008 as shown in FIG. 1E is effective to minimize the image to accommodate a 4×6 inch or some other size print format depending on the lens used. By this means, the “screen door pattern” as discussed above can be reduced, minimized or eliminated.

The exposure member 25′ as shown in FIG. 1E further defines an in line system that could be cost effectively constructed such that after the first print, subsequent prints would appear to “drop” at a rate of 9000 to 10,000 per hour if the apparatus was joined to provide a continuous process flow which involves conveying the media through the steps of imaging; exposure; crushing; heating; and photobleaching.

Media delivery could be in light tight “daylight load” containers or feed could be employed with a cutter at the downstream side of the process.

Furthermore, this device could be customized by optical component selection to provide large format (poster, display) images. Also, the exposure speed that can be realized by the present invention permits the imaging device to be used in an operator assisted minilab or wholesale lab retail environment, as well as in a stand-alone device such as a kiosk where short exposure times are beneficial.

In a further feature of the present invention, brush processing quality could be further enhanced by utilizing two brushes 160a and 160b as shown schematically in FIG. 10, where one brush 160a is rotated perpendicular to the other brush 160b. In this manner, any linear patterning that may be induced by the brush, can be effectively reduced/removed by the action of the second brush.

The invention has been described in detail with particular reference to certain preferred embodiments thereof, but it will be understood that variations and modifications can be effected within the spirit and scope of the invention.

1. An image forming device comprising:
an exposure member adapted to expose a photosensitive medium to form a latent image on the photosensitive medium, said exposure member comprising a light source, a first lens provided in a light path of light from said light source, a shutter provided in said path and a media locating member adapted to locate the photosensitive medium to be exposed at a focused position along the light path relative to the light source, said photosensitive medium comprising a plurality of microcapsules which encapsulate imaging material; and
a processing member adapted to develop the latent image by contacting the photosensitive medium with a force that is sufficient to release imaging material from selected microcapsules.

2. An imaging device according to claim 1, wherein said media locating member is a vacuum easel adapted to hold said photosensitive medium at said focused position.

3. An imaging device according to claim 1, wherein said first lens is adapted to enable printing on media of a first size.

4. An imaging device according to claim 3, further comprising a second lens, each of said first and second lens being provided on a turret which is enabled to rotate said first lens or said second lens into said light path, said second lens being adapted to enable printing on media of a second size.

5. An imaging device according to claim 1, wherein said processing member is a rotatable member having a compliant surface that includes micromembers that contact the photosensitive medium during a rotation of the processing member to apply said force to the photosensitive medium.

6. An imaging device according to claim 1, wherein said processing member is a crushing member and said force is a crushing force applied by said crushing member.

7. An imaging device according to claim 1, wherein said exposure member is a digital projector that is adapted to completely expose a print area surface of the photosensitive medium.

8. An imaging device according to claim 1, wherein said shutter is adapted to control exposure times for exposing the photosensitive media.

9. An imaging device according to claim 1, further comprising a heating device and a photobleaching device.

10. An image forming method comprising:
(i) exposing a photosensitive medium comprising a plurality of microcapsules which encapsulate imaging material top form a latent image;
said exposing step comprising:
a) placing the photosensitive medium in front of a light exposure source having a shutter that permits controlled exposure of the media;
b) placing a first lens between the light exposure source and the photosensitive medium; and
c) exposing said medium by providing light from said light source along a light path that passes through said lens; and
(ii) developing the latent image by contacting a surface of the medium with a processing member that is adapted to apply a force to the surface of the medium which is sufficient to release imaging material from the microcapsules.

11. An image forming method according to claim 10, wherein said step of placing the medium in front of the light exposure source comprises placing the medium on a vacuum easel at a focused position from the light source.

12. An image forming method according to claim 10, wherein said first lens is adapted to print on media of a first size.

13. An image forming method according to claim 12, further comprising placing said first lens and a second lens which is adapted to print on media of a second size on at turret, and rotating the turret to place either the first lens or the second lens in said light path based on a desired media size.

14. An image forming method according to claim 10, wherein said processing member comprises a compliant surface with micromembers and said developing step comprises rotating the processing member to contact the spinning micro-members with the medium.

15. An image forming method according to claim 10, wherein said developing step comprises applying a crushing force to said microcapsules.

16. An image forming method according to claim 10, wherein said exposing step comprises using a digital projector that is adapted to completely expose a print area surface of the photosensitive medium.

17. An image forming method according to claim 10, further comprising the steps of:
heating said photosensitive medium; and
photobleaching said photosensitive medium.
